(19) United States
(12) Patent Application Publication
(10) Pub. No.: US 2026/0238572 A1
(43) Pub. Date: Aug. 13, 2026

(54) PACKET LOSS DETECTION IN MULTIPATH NETWORKS

(71) Applicant: Microsoft Technology Licensing, LLC, REDMOND, WA (US)

(72) Inventors: Yevgeny YANKILEVICH, Tirat Carmel (IL); Assaf SHACHAM, Zichron Yaakov (IL); Abdul KABBANI, Menlo Park, CA (US); Konstantin TARANOV, Zurich (CH); Mahmoud ELHADDAD, Newcastle, WA (US); Idan Moshe REGEV, Adamit (IL); Tao JI, Bellevue, WA (US)

(21) Appl. No.: 19/049,166

(22) Filed: Feb. 10, 2025

(51) Int. Cl. H04L 43/0829; H04L 45/24; H04L 69/164

(52) U.S. Cl. CPC H04L 43/0829; H04L 45/24; H04L 69/164

(57) ABSTRACT

Methods, apparatuses, and products for packet loss detection in multipath networks, including: encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path; sending, by the source endpoint and to a destination endpoint of the multipath network connection, the plurality of packets via the plurality of paths; and performing, by the destination endpoint, packet loss detection based on the entropy value and the path-specific sequence number for the plurality of packets.

### BACKGROUND

When sending data packets over a network, it is possible for some of these packets to be lost during transfer. For example, network congestion occurs when switches or other network components become overburdened, which may lead to packet loss. Unaddressed packet loss may cause the data transfer to fail or may introduce errors or corruption in the data that was successfully received. Accordingly, packet loss detection allows for a recipient of data packets to detect missing packets. The recipient may then request that the sender retransmit these missing packets to complete the data transfer.

Packets may be sent with a packet sequence number (PSN) indicating where each packet occurs in a sequence of packets. This PSN may be incremented as each packet has been sent. When the packets are sent using a single path, each packet should be received in the order in which it was sent. If the PSN of a received packet is not the next PSN in the sequence, this indicates that the packet that should have the next PSN in the sequence was likely lost. Though this approach may be used for network connections using a single network path, the PSN alone may be inadequate for packet loss detection in multipath network connections.

Multipath network connections may be used to distribute network traffic in parallel across multiple paths, thereby increasing the total available bandwidth, mitigating congestion on any single route, and allowing for continued data transfer should one path fail. Latencies may differ across these network paths, which may cause some packets to be received in a different order than they were sent. Accordingly, in multipath network connections, receiving a packet with an out-of-order PSN is not necessarily indicative of packet loss. In some existing implementations, where a packet is received with an out-of-order PSN, the recipient may wait for the missing packets up to some time limit. This gives the missing packets time to arrive should they be delayed due to latency.

If the missing packets have not arrived by the end of the time limit it can be assumed that the packets were lost, not merely delayed. Though this approach may be used to identify lost packets, it introduces a delay between when an out-of-order packet is detected and when a missing packet can be deemed lost. Moreover, in some implementations, both the missing packets and any packets sent after must also be resent, further increasing the resource utilization and completion time of the data transfer.

### SUMMARY

According to embodiments of the present disclosure, various methods, apparatus, and products for packet loss detection in multipath networks are described herein. In some aspects, packet loss detection in multipath networks includes: encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path; sending, by the source endpoint and to a destination endpoint of the multipath network connection, the plurality of packets via the plurality of paths; and performing, by the destination endpoint, packet loss detection based on the entropy value and the path-specific sequence number for the plurality of packets. In some aspects, an apparatus may include a memory and one or more processing devices, operatively coupled to the memory, the one or more processing devices configured to perform similar steps. In some aspects, a computer program product comprising a computer readable storage medium may store computer program instructions that, when executed, perform similar steps.

### BRIEF DESCRIPTION OF DRAWINGS

FIG. 1 sets forth a diagram of an example system for packet loss detection in multipath networks in accordance with some embodiments of the present disclosure.

FIG. 2 sets forth a flow chart illustrating an example method of packet loss detection in multipath networks in accordance with some embodiments.

FIG. 3 sets forth a flow chart illustrating an additional example method of packet loss detection in multipath networks in accordance with some embodiments.

FIG. 4 sets forth a flow chart illustrating an additional example method of packet loss detection in multipath networks in accordance with some embodiments.

FIG. 5 sets forth a flow chart illustrating an additional example method of packet loss detection in multipath networks in accordance with some embodiments.

FIG. 6 sets forth a flow chart illustrating an additional example method of packet loss detection in multipath networks in accordance with some embodiments.

FIG. 7 sets forth a flow chart illustrating an additional example method of packet loss detection in multipath networks in accordance with some embodiments.

FIG. 8 sets forth a flow chart illustrating an additional example method of packet loss detection in multipath networks in accordance with some embodiments.

FIG. 9 illustrates an exemplary computing device that may be specifically configured to perform one or more of the processes described in the present disclosure.

FIG. 10 sets forth a block diagram of a cloud service provider service architecture in accordance with some embodiments of the present disclosure.

### DESCRIPTION OF EMBODIMENTS

When sending data packets over a network, it is possible for some of these packets to be lost during transfer. In order to prevent packet loss from causing the data transfer to fail, the recipient may request any missing packets from the sender so as to complete the data transfer. Accordingly, a recipient should be able to accurately detect when a packet from a data transfer has been lost. In some existing implementations, the packets to be transferred are assigned a packet sequence number (PSN), a value that is incremented from its initial negotiated value as each packet has been sent. When the packets are sent using a single path, each packet should be received in the order in which it was sent. If the PSN of a received packet is not the next PSN in the sequence, this indicates that the packet that should have the next PSN in the sequence was likely lost.

Although PSNs may be useful in detecting packet loss over a single network path, this solution may not be sufficient in multipath network connections. In a multipath network connection, packets are sent from a source to a destination using multiple paths. This may provide increased bandwidth and redundancy by leveraging many different routes to the destination simultaneously. As these multiple paths may have different latencies from the source to the destination it is possible that the packets may be received by the recipient in a different order than the order in which they were sent. Accordingly, in multipath network connections, receiving a packet with an out-of-order PSN is not necessarily indicative of packet loss. Existing implementations for packet loss detection in multipath network connections may allow for a recipient to wait a predefined amount of time for a missing packet so as to distinguish between truly lost packets and packets that were only delayed due to latency, but this introduces a delay between receiving a packet with an out-of-order PSN and determining if a packet was actually lost.

To address these shortcomings, the approaches set forth herein allow for packet loss detection in multipath network connections. Each path of the multipath network connection may be assigned an entropy value such that packets with the included entropy value will be routed along the corresponding path. Each packet is also assigned a path-specific sequence number, a value that is incremented for each packet that is sent along the same path (e.g., using the same entropy value). Each packet sent along the same path should be received in the order in which they were sent along that path. A recipient of the data packets may then detect lost packets by determining if a packet is received with an out-of-order (e.g., non-sequential) path-specific sequence number for the corresponding path.

Unaddressed packet loss can have many negative consequences for a user, including performance degradation, data corruption, or unexpected errors. Packet loss detection is therefore important in minimizing any potential negative impacts on users. The approaches set forth herein provide for an approach for detecting packet loss for multipath network connections. This improves the overall user experience by allowing for the performance benefits provided by multipath network connections while minimizing potential negative impacts caused by packet loss. Networks that implement such techniques may therefore be more reliable, higher performant, and may experience greater adoption. Likewise, product offerings that leverage these techniques, such as cloud computing environments that leverage this form of reliable, multipath data communications, may be able to offer higher performing, more reliable cloud services based on the improvements to the underlying data communications that take place between different cloud resources.

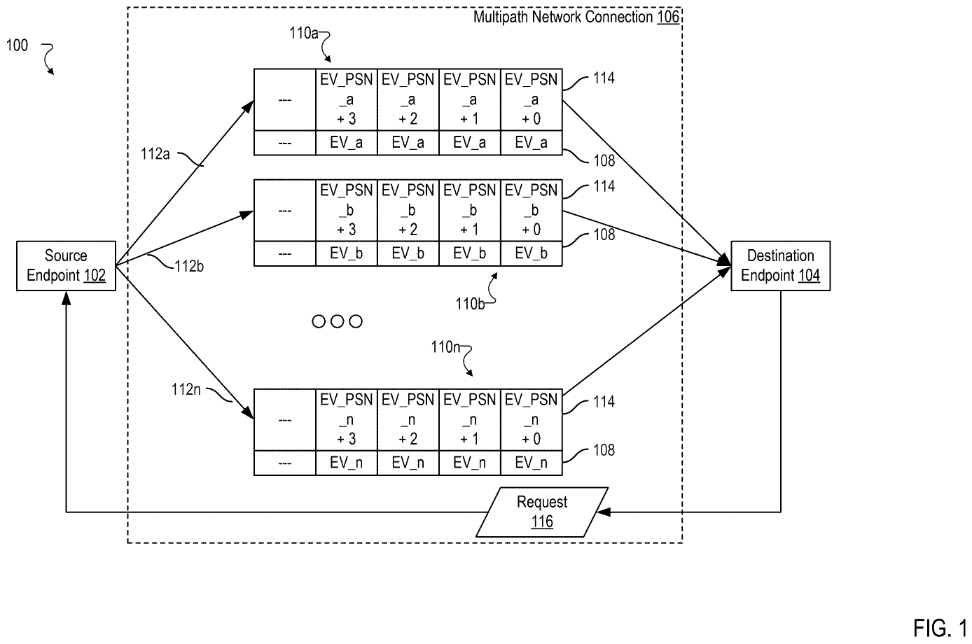

FIG. 1 sets forth a diagram of an example system 100 for packet loss detection in multipath networks in accordance with some embodiments. The system 100 of FIG. 1 includes a source endpoint 102 and a destination endpoint 104. The source endpoint 102 and destination endpoint 104 are each endpoints of a multipath network connection 106, a network connection whereby network traffic may travel across multiple paths concurrently. In this example, the source endpoint 102 is a source from which some data will be sent to the destination endpoint 104. The source endpoint 102 and destination endpoint 104 may include, for example, physical or virtual computing devices, nodes, software applications, and the like.

The data to be sent from the source endpoint 102 to the destination endpoint 104 may be encoded as a plurality of packets to be sent across a packet-switched network. Each packet may include an entropy value 108 (e.g., in the header). An entropy value 108 is a configurable value included in a combination of parameters that determine which network path of multiple network paths the packet may traverse from the source endpoint 102 to the destination endpoint 104. For example, in some embodiments, networking components such as routers or switches may perform Equal Cost Multipath (ECMP) hashing or another hash-based routing algorithm whereby a hash value is calculated for one or more values in the header of a packet (e.g., by applying a hash function to these one or more values). Particularly, in some embodiments, the hash value may be calculated based on one or more header fields that do not change during a network connection unless explicitly modified. The hash value then determines how the packet will be routed. Thus, packets with the same hash value will be routed and travel along the same network path.

Accordingly, the entropy value 108 may include one of the values from which a hash value is calculated for hash-based routing. This may include, for example, a User Datagram Protocol (UDP) source port header field or another header field as can be appreciated. Each packet with the same entropy value 108 will then traverse the same network path from the source endpoint 102 to the destination endpoint 104. In this example system, a set of packets 110a having an entropy value 108 of “EV_a” will traverse network path 112a, a set of packets 110b having an entropy value 108 of “EV_b” will traverse network path 112b, and so forth, up to a set of packets 110a having an entropy value 108 of “EV_n” traversing a network path 112n. Thus, packets 110a,b-n having N different entropy values 108 will use N different network paths 112a, b-n.

Although not shown, each packet 110a,b-n may also include a packet sequence number (PSN). A PSN serves to indicate where each packet 110a,b-n is included in an ordered sequence of all packets 110a,b-n. As is described above, in some existing solutions, the PSN may be used to detect packet loss when it can be assumed that all packets should arrive in the same order in which they were sent. As the multipath network connection 106 uses multiple network paths 112a,b-n it cannot be guaranteed that the packets 110a,b-n will arrive at the destination endpoint 104 in the same order in which they were sent from the source endpoint 102 due to variations in latencies across the different network paths 112a,b-n. Accordingly, the PSN is not a reliable basis for detecting packet loss across a multipath network connection 106.

To address these shortcomings, each packet 110a,b-n also includes a path-specific sequence number 114, which may also be referred to as an entropy packet sequence number or “EV_PSN.” A path-specific sequence number 114 indicates where each packet 110a,b-n is included in a sequence of packets 110a,b-n as sent along a specific network path 112a,b-n. For example, a path-specific sequence number 114 for packets 110a indicates the order in which each packet 110a was sent along the network path 112a, a path-specific sequence number 114 for packets 110b indicates the order in which each packet 110b was sent along the network path 112b, and a path-specific sequence number 114 for packets 110n indicates the order in which each packet 110n was sent along the network path 112n. Thus, in some embodiments, to send a particular packet 110a,b-n along a particular network path 112a,b-n, the source endpoint 102 calculates a new path-specific sequence number 114 by incrementing the last-used path-specific sequence number 114 for that network path 112a,b-n. In some embodiments, each network path 112a,b-n may have its own range or space of path-specific sequence numbers 114 (e.g., an EV_PSN space).

Assuming no packet loss, each packet 110a,b-n within a particular set of packets 110a,b-n should arrive at the destination endpoint 104 in the same order in which they were sent from the source endpoint 102 compared to other packets 110a,b-n in that set of packets 110a,b-n. For example, all packets 110a should arrive in the same order that they were sent relative to other packets 110a. In this example, the destination endpoint 104 should receive, in order, packets 110a with EV_PSN_a, then EV_PSN_a+1, EV_PSN_a+2, and so forth. In other words, although there is no guarantee that all packets 110a,b-n will arrive in the order in which they were sent from the source endpoint 102, the packets 110a,b-n sent along a particular network path 112a,b-n should arrive at the destination endpoint 104 in the order in which they were sent along the particular network path 112a,b-n.

Accordingly, the path-specific sequence number 114 may be used to detect packet loss along the multipath network connection 106. For example, assume that the destination endpoint 104 receives, from the source endpoint 102 via the network path 112b, a first packet 110b with EV_PSN_b, then a second packet 110b with EV_PSN_b+1, then a third packet 110b with EV_PSN_b+3. Here, the destination endpoint 104 should have received a packet 110b with EV_PSN_b+2 between the second and third packet 110b. It can therefore be presumed that this packet 110b with EV_PSN_b+2 was lost during transfer. In other words, the destination endpoint 104 may perform packet loss detection by comparing, for a given packet 110a,b-n, an expected path-specific sequence number 114 and the actual path-specific sequence number 114 for the given packet 110a,b-n to detect an out-of-order (e.g., not sequentially next) path-specific sequence number 114 for the given packet 110a,b-n.

In response to detecting a missing packet 110a,b-n, the destination endpoint 104 may send, to the source endpoint 102, a request 116 for the missing packet 110a,b-n. Continuing with the example above, the destination endpoint 104 may send a request 116 to the source endpoint 102 for a missing packet 110b with EV_PSNb+2. In some embodiments, this request 116 may include a selective acknowledgement (SACK) indicating the missing packet 110b. In some embodiments, the missing packet 110b may be identified in the request 116 using its path-specific sequence number 114 (e.g., EV_PSNb+2). In some embodiments, depending on the particular approaches used by the source endpoint 102 in assigning entropy values 108 to packets to be sent, the destination endpoint 104 may be able map the path-specific sequence number 114 of the missing packet 110b back to its PSN. Accordingly, in some embodiments, the request 116 may identify the missing packet 110b using its PSN.

In response to the request 116, the source endpoint 102 may then resend the missing packet 110b. In some embodiments, the missing packet 110b may be resent using the same network path 112b (e.g., and entropy value 108) as was used when initially sending the missing packet 110b. In some embodiments, the missing packet 110b may be resent using different network paths 112a,b-n. In embodiments where the missing packet 110b is identified using a path-specific sequence number 114, the source endpoint 102 may select the missing packet 110b for retransmission using its PSN by mapping the path-specific sequence number 114 back to its PSN. After receiving all packets 110a,b-n, the destination endpoint 104 may reconstruct the data using the PSN of the received packets 110a,b-n.

The source endpoint 102 may assign entropy values 108, and thereby select a network path 112a,b-n, for packets 110a,b-n to be sent according to various approaches. In some embodiments, the source endpoint 102 may randomly assign an entropy value 108 to each packet from a selection of possible entropy values 108 each corresponding to a different network path 112a,b-n. For example, where the source endpoint 102 is to use four network paths 112a,b-n, the source endpoint 102 may randomly assign an entropy value 108 from a selection of four possible entropy values 108.

In some embodiments, the source endpoint 102 may assign a block or range of packets 110a,b-n (e.g., having a block or range of PSNs) the same entropy value 108 so as to be sent along the same network path 112a,b-n. After sending this block or range of packets 110a,b-n, the source endpoint 102 may then assign a different entropy valve 108 to another block or range of packets 110a,b-n. This process may then repeat, potentially repeatedly cycling through the selection of possible entropy values 108 until all packets 110a,b-n have been sent.

In some embodiments, the source endpoint 102 may send packets 110a,b-n to the destination endpoint 104 using even packet spraying whereby packets 110a,b-n are evenly spread across active network paths 112a,b-n. In some embodiments, the source endpoint 102 may send packets 110a,b-n using round robin packet spraying whereby each pack 110a,b-n is sent along the next network path 112a,b-n in rotating sequence of network paths 112a,b-n. For example, assuming a sequence of four network paths 112a,b-n, the first four packets 110a,b-n may each be sent using a different network path 112a,b-n of the sequence. The fifth packet 110a,b-n may then be sent using the first network path 112a,b-n, restarting the rotating sequence of network paths 112a,b-n.

In some embodiments, where round robin packet spraying is used, the source endpoint 102 may determine a path index for each packet 110a,b-n. The path index serves to identify a particular network path 112a,b-n of multiple network paths 112a,b-n and may be mapped to a corresponding entropy value 108. For example, assuming N network paths 112a,b-n and zero-based indexing, the path index may include a value from zero to N−1. Here, the path index PATH_ID for a given packet 110a,b-n may be determined by calculating the PSN modulo N (PATH_ID % N). This PATH_ID then specifies which entropy value 108 should be used for that packet 110a,b-n. Readers will appreciate that, using this approach, the destination endpoint 104 may map path-specific sequence numbers 114 for missing packets 110a,b-n back to their PSN (e.g., for inclusion in a request 116) as PSN=(EV_PSN×N)+PATH_ID.

During setup of the multipath network connection 106, a connection manager (CM) or another entity may determine how many network paths 112a,b-n should be used. Each PATH_ID is then assigned a specific entropy value 108 for use. In some embodiments, the source endpoint 102 may need to be able to select a new entropy value 108 for a particular PATH_ID in response to congestion control (CC) signals, thereby changing the corresponding network path 112a,b-n for that PATH_ID. In some embodiments, the destination endpoint 104 may need to identify the PATH_ID from the entropy value 108 of a received packet 110a,b-n, thereby allowing the destination endpoint 104 to correlate packets 110a,b-n sharing a PATH_ID should the entropy value 108 change during transmission.

In some embodiments, the entropy value 108 may be encoded using a first subset of bits encoding a changing value and a second subset of bits encoding the PATH_ID. For example, the PATH_ID may be encoded using a subset of lowest-order bits of the entropy value 108. In some embodiments, the changing value itself may include a constant component and a dynamically incremented component. In this example, the entropy value 108 may be changed by incrementing the dynamically incremented component of the changing value. Thus, the destination endpoint 104 can identify a PATH_ID from an entropy value 108 using the lowest-order bits of the entropy value 108, which will be unaffected when updating the entropy value 108 by the source endpoint 102. In some embodiments, parameters and algorithms for both defining the constant component and how the dynamically incremented component is incremented may be configured to enhance the probability of changing the network path 112a,b-n each time the entropy value 108 is updated. In some embodiments, the entropy value 108 may be updated or changed using other approaches that preserve a subset of bits encoding the PATH_ID.

Readers will appreciate that the approaches set forth above allow for packet loss detection over multipath network connections. This mitigates potential performance degradation caused by lost packets, improving overall system performance. In contrast to existing implementations using Responder Timeouts, whereby a recipient may wait a predefined amount of time for a missing packet before deeming it to be lost, the approaches set forth above allow for immediate detection of missing packets when receiving a packet with an out-of-order EV_PSN, improving overall response time and system utility.

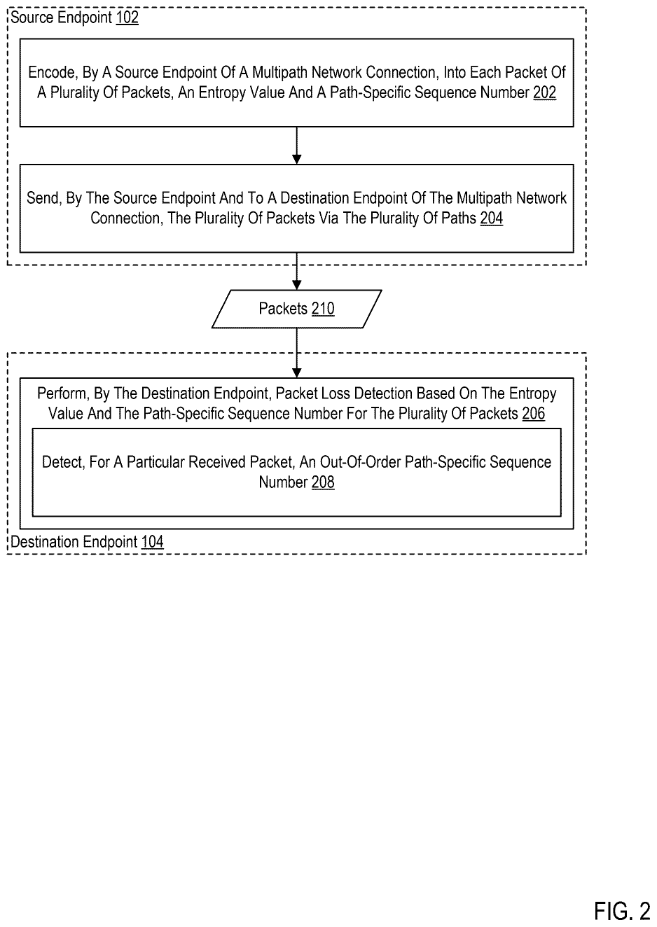

For further explanation, FIG. 2 sets forth a flowchart of an example method of packet loss detection in multipath networks in accordance with some embodiments of the present disclosure. The method of FIG. 2 may be performed, for example, using the system 100 of FIG. 1. The method of FIG. 2 includes encoding 202, by a source endpoint 102 of a multipath network connection 106, into each packet 210 of a plurality of packets 210, an entropy value 108 and a path-specific sequence number 114. The entropy value 108 may include a value of a header field for each packet 210 that determines which network path of multiple network paths will be used to transfer a given packet 210 to the destination endpoint 104.

For example, using hash-based routing such as Equal Cost Multipath (ECMP) hashing, each network component may determine where to route a packet 210 by calculating a hash value for 210 using one or more header fields of the packet 210. Thus, packets 210 having the same hash value will be routed along the same network path. In this example, the entropy value 108 may include a value from which this hash value is calculated. Particularly, any header field other than the entropy value 108 used in calculating the hash value may remain identical across all packets 210 such that all packets 210 with the same entropy value 108 will have the same hash value and will therefore be routed along the same network path of the multipath network connection 106. In some embodiments, the entropy value 108 may include a UDP source port or another header field as can be appreciated.

In some embodiments, a connection manager (CM) or another entity may determine a number of network paths to be used in the multipath network connection 106, such as during establishment of the multipath network connection. In some embodiments, an entropy value 108 may be calculated for each network path, which may then be mapped to a path index (e.g., a PATH_ID) for the corresponding network path. In some embodiments, the entropy value 108 for each network path may be calculated or determined based on the corresponding PATH_ID. Thus, should an entropy value 108 for a particular PATH_ID require updating over time, the destination endpoint 104 will be able to determine the PATH_ID from the updated entropy value 108.

The path-specific sequence number 114 or EV_PSN indicates an order in which packets 210 were sent along a particular network path. Accordingly, to encode the path-specific sequence number 114 for a packet 210 to be sent along a particular network path (e.g., using a particular entropy value 108), the source endpoint 102 will increment the path-specific sequence number 114 for the last packet 210 to be sent using that particular network path. In some embodiments, each network path or entropy value 108 may have a corresponding EV_PSN space defining a range or set of path-specific sequence numbers 114 usable for the corresponding network path or entropy value 108.

The method of FIG. 2 also includes, sending 204, by the source endpoint 102 and to the destination endpoint 104 of the multipath network connection 106, the plurality of packets via the plurality of paths. Each packet 210 includes an entropy value 108 that determines which network path will be used for transferring the packet 210 due to hash-based routing. Accordingly, sending 204 the plurality of packets via the plurality of paths may include sending, by the source endpoint 102, the plurality of packets to a network component that will then route the packets 210 based on their entropy value 108.

Readers will appreciate that the entropy value 108 and/or the path-specific sequence number 114 for a given packet 210 may be dependent on a packet 210 or packets 210 previously encoded and sent to the destination endpoint 104. Accordingly, although encoding 202 the entropy value 108 and the path-specific sequence number 114 and sending 204 the plurality of packets 210 are shown as separate steps, readers will appreciate that these steps may be performed at least partially in parallel and/or in an alternating fashion for individual packets 210 or sets of packets 210.

In some embodiments, the source endpoint 102 may encode 202 entropy values 108 and send 204 packets along different network paths according to various approaches. In some embodiments, the source endpoint 102 may select a range or block of packets 210 (e.g., based on their PSN ordering) and assign that subset of packets 210 the same entropy value 108 so that they will be sent 204 along the same network path. For example, assuming N network paths, the source endpoint 102 may assign the first M packets 210 the entropy value 108 of a first network path, the second M packets 210 the entropy value 108 of a second network path, and so forth. After assigning a set of M packets 210 the entropy value 108 of the Nth network path, the next set of M packets 210 may be assigned the entropy value 108 of the first network path, repeating the process above until all packets 210 are assigned entropy values 108 and sent along their corresponding network paths. Readers will appreciate that, in some embodiments, the number of packets 210 in any given range or block of packets 210 may be the same or different across the different entropy values 108.

In some embodiments, the source endpoint 102 may randomly select an entropy value 108 for each packet 210. For example, the source endpoint 102 may randomly select an entropy value 108 from a selection of possible entropy values. In some embodiments, this may include randomly selecting, for a packet 210, a PATH_ID of possible PATH_IDs and encode, in that packet 210, the corresponding entropy value 108. In some embodiments, the source endpoint 102 may evenly distribute packets 210 along different network paths using even packet spraying such as round-robin packet spraying, to be described in further detail below.

The method of FIG. 2 also includes performing 206, by the destination endpoint 104, packet loss detection based on the entropy value 108 and path-specific sequence number 114 for the plurality of packets 210. Each subset of the plurality of packets 210 sent 204 by the source endpoint 102 along a particular network path should be received, by the destination endpoint 104, in the order in which they were sent along that particular network path, assuming that no packet loss has occurred. In other words, assuming no packet loss, each packet 210 received from a particular network path should have the next path-specific sequence number 114 relative to the last packet 210 received via that particular network path. Receiving a packet 210 with any other path-specific sequence number 114 (e.g., an out-of-order path-specific sequence number) indicates packet loss.

Accordingly, in some embodiments, performing 206, by the destination endpoint 104, packet loss detection based on the entropy value 108 and path-specific sequence number 114 for the plurality of packets 210 includes detecting 208, for a particular received packet 210, an out-of-order path-specific sequence number 114. Detecting 208 an out-of-order path-specific sequence number 114 may include calculating an expected path-specific sequence number 114 by incrementing the path-specific sequence number 114 of the last packet 210 received for a particular PATH_ID. This may include, for example, the last packet 210 received via a particular network path and having a particular entropy value 108. In some embodiments, the entropy value 108 and corresponding network path may change for a particular PATH_ID. Accordingly, in some embodiments, this may include the last packet 210 received for a particular PATH_ID that may not necessarily have the same entropy value 108 and network path. This expected path-specific sequence number 114 may then be compared to the actual path-specific sequence number of the particular received packet 210. A difference between these expected and actual values indicates that the particular received packet 210 includes an out-of-order path-specific sequence number 114.

For example, assume that a packet 210 is received via a particular network path that has a path-specific sequence number 114 of EV_PSN+2. Further assume that the next packer 210 received via that particular network path has a path-specific sequence number 114 of EV_PSN+4. Here, the actual value of the path-specific sequence number 114, EV_PSN+4, differs from the expected value of EV_PSN+3. Accordingly, the path-specific sequence number of 114 of EV_PSN+4 is out-of-order, indicating a lost packet with EV_PSN+3.

In some embodiments, no packets 210 may have been lost during transmission to the destination endpoint 104. Accordingly, in some embodiments, performing 206 packet loss detection may include determining that no packets 210 were lost. This may include determining that each packet 210 includes an in-order path-specific sequence number 114 relative to other packets 210 sharing the same network path and entropy value 108 and/or corresponding to the same PATH_ID.

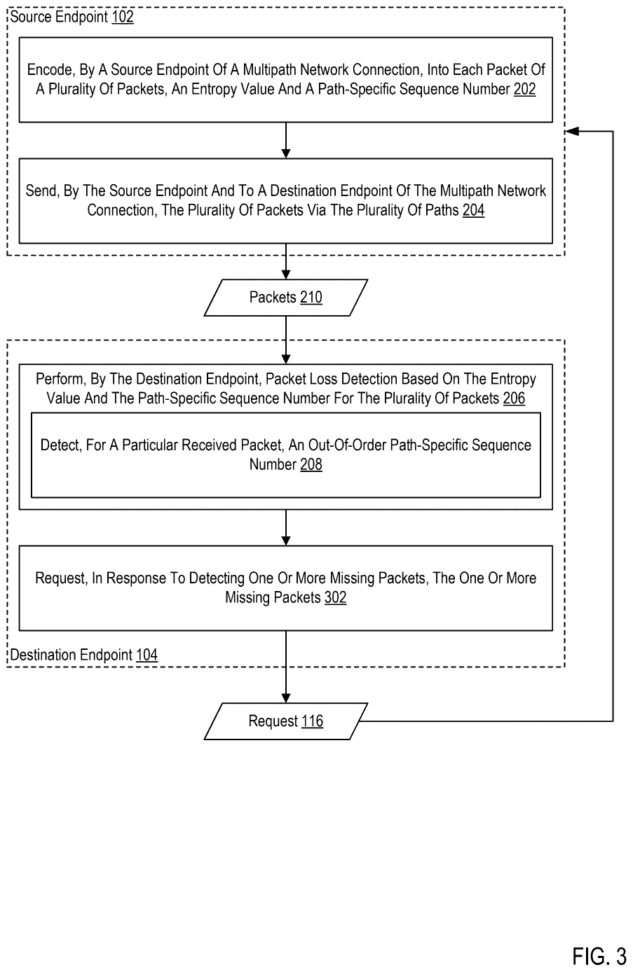

For further explanation, FIG. 3 sets forth a flowchart of another example method of packet loss detection in multipath networks in accordance with some embodiments of the present disclosure. The method of FIG. 3 also includes requesting 302 (e.g., by the destination endpoint 104), in response to detecting one or more missing packets, the one or more missing packets. In some embodiments, requesting 302 the one or more missing packets may include sending, by the destination endpoint 104, a request 116 indicating the one or more missing packets. In some embodiments, the request 116 may be sent using one of the network paths described above for sending 204 the plurality of packets 210 to the destination endpoint 104. In some embodiments, the request 116 may be sent using another network path of the multipath network connection 106. In some embodiments, the request 116 may be sent using a different network connection between the source endpoint 102 and the destination endpoint 104.

In some embodiments, the request 116 may include a selective acknowledgement (SACK) or other message that identifies the one or more missing packets. In some embodiments, the request 116 may identify the one or more missing packets using their path-specific sequence number 114. In some embodiments, the request 116 may identify the one or more missing packets using their PSN. For example, in some embodiments, the destination endpoint 104 may be able to map the path-specific sequence number 114 of packets 210 back to their PSN for inclusion in the request 116.

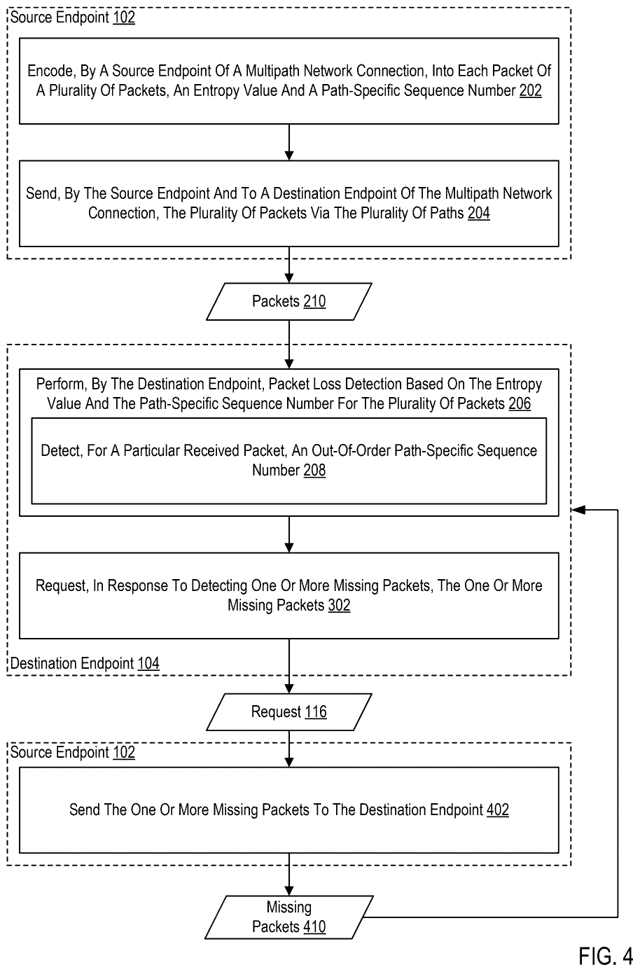

For further explanation, FIG. 4 sets forth a flowchart of another example method of packet loss detection in multipath networks in accordance with some embodiments of the present disclosure. The method of FIG. 4 includes sending 402 (e.g., by the source endpoint 102) the one or more missing packets (shown as missing packets 410) to the destination endpoint 104. In some embodiments, where the request 116 identifies the missing packets 410 using their PSN, the source endpoint 102 may select the missing packets 410 using the PSN and send the selected missing packets 410 to the destination endpoint 104. In some embodiments, where the request 116 identifies the missing packets 410 using their path-specific sequence number 114, the source endpoint 102 may map or convert the identified path-specific sequence numbers 114 into their corresponding PSNs before selecting and sending the missing packets 410 as described above.

In some embodiments, the source endpoint 102 may send 402 the one or more missing packets 410 using the same network path as was used to initially send 204 them to the destination endpoint 104. For example, the missing packets 410 may be sent 402 with the same entropy values 108 as when initially sent 204 so that they may be routed along the same network path. In some embodiments, the source endpoint 102 may send 402 the one or more missing packets using a different network path than was used to initially send 204 them to the destination endpoint. For example, in some embodiments, the missing packets 410 may be sent with updated entropy values 108. In some embodiments, entropy values 108 may encode the PATH_ID to which they are mapped (e.g., as lower-order bits). Accordingly, in some embodiments, the missing packets 410 may be sent with updated entropy values 108 that preserve their PATH_ID but include other differing (e.g., higher-order) bits. This may allow the missing packets 410 to be routed using different network paths than were initially used but with the same PATH_ID. In some embodiments, the missing packets 410 may be sent using different network paths independent of their original PATH_ID.

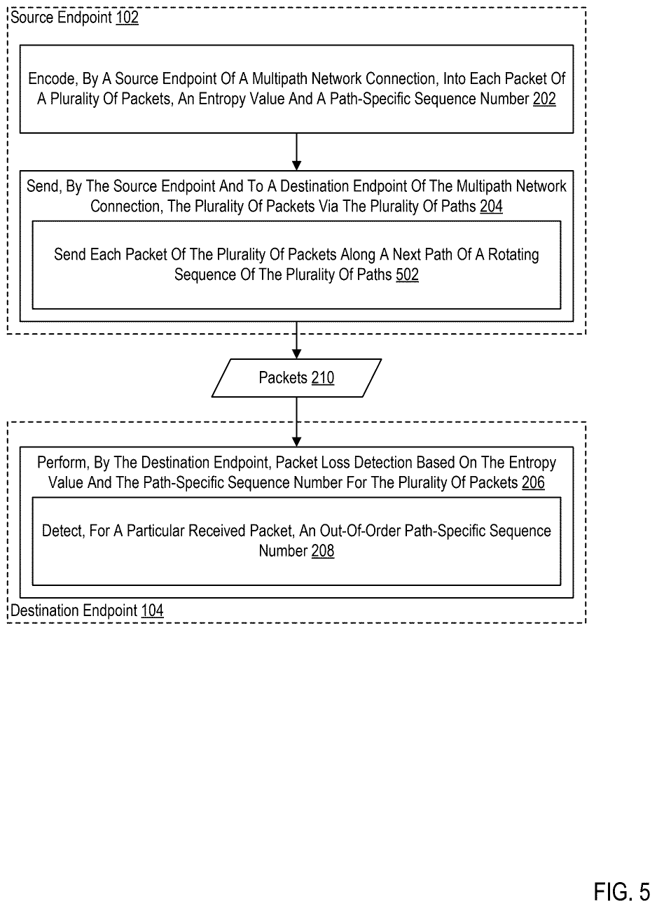

For further explanation, FIG. 5 sets forth a flowchart of another example method of packet loss detection in multipath networks in accordance with some embodiments of the present disclosure. The method of FIG. 5 differs from previous figures in that sending 204, by the source endpoint 102 and to the destination endpoint 104 of the multipath network connection 106, the plurality of packets via the plurality of paths also includes sending 502 each packet of the plurality of packets along a next path of a rotating sequence of the plurality of paths. In other words, in some embodiments, sending 204 the plurality of packets via the plurality of paths includes sending 204 the plurality of packets using round robin packet spraying. This approach allows for even distribution of packets 210 across different network paths, distributing the network burden across these network paths with low implementation complexity.

For example, in some embodiments, assuming N network paths, a first packet 210 may be sent along a first network path, a second packet 210 may be sent along a second network path, and so forth. After sending a packet 210 along the Nth network path, the next packet 210 will be sent along the first network path, repeating the rotating sequence of network paths. As the particular path used by a packet 210 is dependent on the entropy value 108 of that packet 210, encoding 202 the entropy value 108 into the plurality of packets may include encoding, into each packet 210, the next entropy value 108 in a rotating sequence of entropy values corresponding to the rotating sequence of network paths.

Readers will appreciate that using round robin packet spraying allows for the destination endpoint 104 to map path-specific sequence numbers 114 back to PSNs, allowing for missing packets to be identified in requests using their PSNs. For example, in some embodiments, to perform round robin packet spraying across N network paths, the source endpoint 102 may determine the PATH_ID for each packet 210 as the PSN of the packet 210 modulo N. The entropy value 108 mapped to the determined PATH_ID may then be encoded into the packet 210. The PSN may then be calculated from the EV_PSN (e.g., by the destination endpoint 104) as PSN=(EV_PSN×N)+PATH_ID.

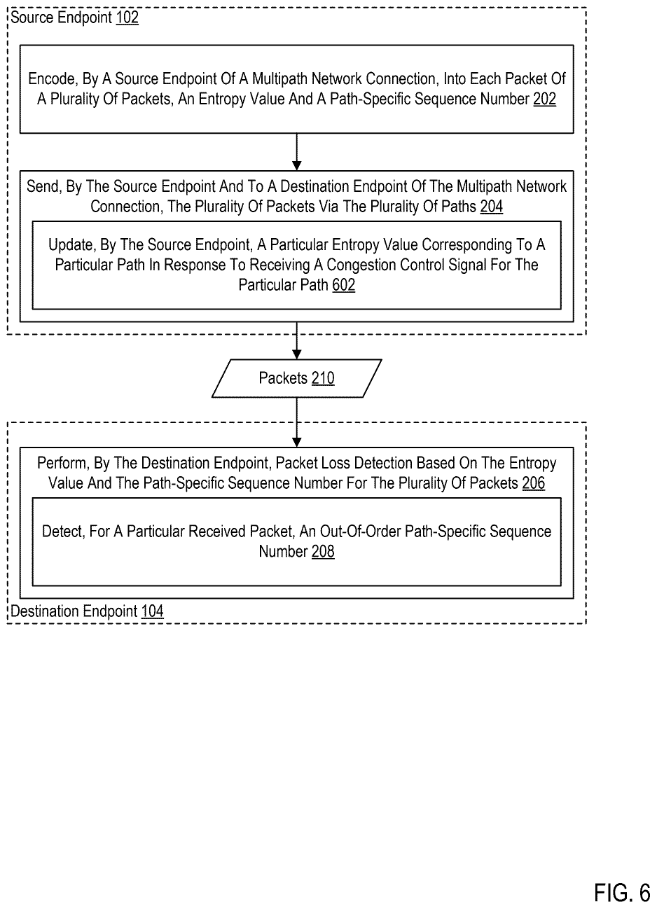

For further explanation, FIG. 6 sets forth a flowchart of another example method of packet loss detection in multipath networks in accordance with some embodiments of the present disclosure. The method of FIG. 6 differs from previous figures in that sending 204, by the source endpoint 102 and to the destination endpoint 104 of the multipath network connection 106, the plurality of packets via the plurality of paths also includes updating 602, by the source endpoint 102, a particular entropy value 108 corresponding to a particular path in response to receiving a congestion control signal for the particular path. A congestion control signal includes a detected event indicative of network congestion. For example, in some embodiments, the source endpoint 102 may monitor various performance metrics related to sending packets 210 to the destination endpoint 104. These metrics may include, for example a round-trip time for a packet 210 and its corresponding acknowledgement, an end-to-end trip time (e.g., the time it takes for data to travel from the source endpoint 102 to the destination endpoint or vice versa), or other metrics can be appreciated. A congestion control signal may then include these performance metrics exceeding some threshold.

In some embodiments, a congestion control signal for a particular path may include a congestion control signal related to data sent or received via a particular network path, thereby indicating that some component along that network path is or is becoming congested. Accordingly, it may be beneficial to use a different network path to avoid these congested components. To use a different network path, the packets 210 that would be sent via that network path must use a different entropy value 108 so as to be routed differently. Accordingly, the source endpoint 102 may update 602 the entropy value 108 for a PATH_ID corresponding to the congested network path. Thus, the mapping of the PATH_ID will be updated to reflect the updated 602 entropy value 108.

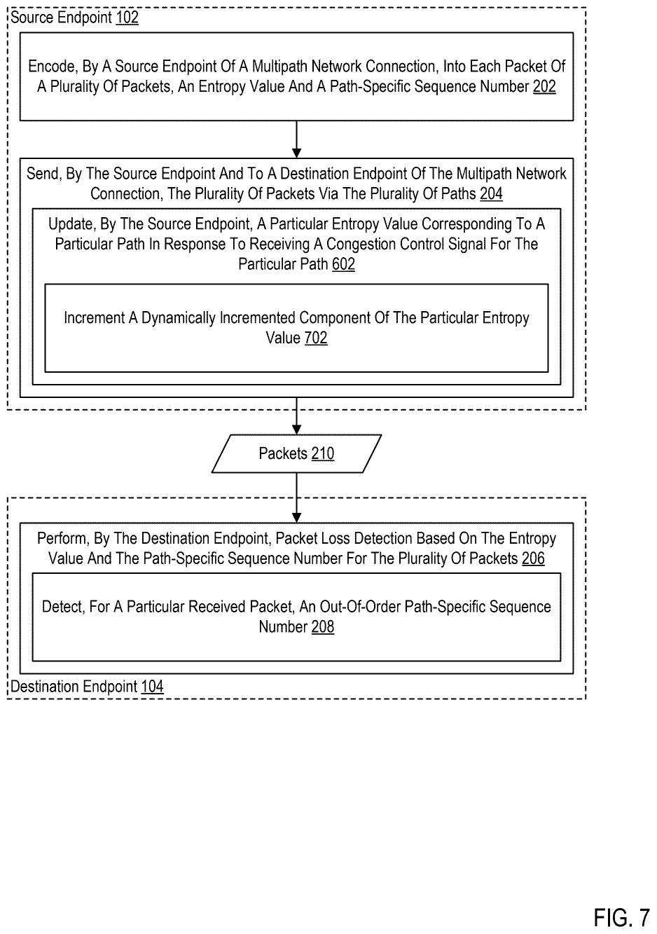

For further explanation, FIG. 7 sets forth a flowchart of another example method of packet loss detection in multipath networks in accordance with some embodiments of the present disclosure. The method of FIG. 7 differs from previous figures in that updating 602, by the source endpoint 102, a particular entropy value 108 corresponding to a particular path in response to receiving a congestion control signal for the particular path also includes incrementing 702 a dynamically incremented component of the particular entropy value 108. In some embodiments, the entropy value 108 may be encoded using a first subset of bits encoding a changing value and a second subset of bits encoding the PATH_ID. For example, the PATH_ID may be encoded using a subset of lowest-order bits of the entropy value 108. In some embodiments, the changing value itself may include a constant component and a dynamically incremented component. In this example, the entropy value 108 may be updated 602 by incrementing the dynamically incremented component of the changing value. This allows for the entropy value 108 to be updated 602 while preserving the PATH_ID encoded therein.

In some embodiments, parameters and algorithms for both defining the constant component and how the dynamically incremented component is incremented may be configured to enhance the probability of changing the network path each time the entropy value 108 is updated 602. Readers will appreciate that, in some embodiments, this approach for updating 602 entropy values 108 is merely exemplary and that other approaches may also be used. Particularly, in some embodiments, other approaches may be used for updating 602 entropy values that preserve a PATH_ID encoded therein.

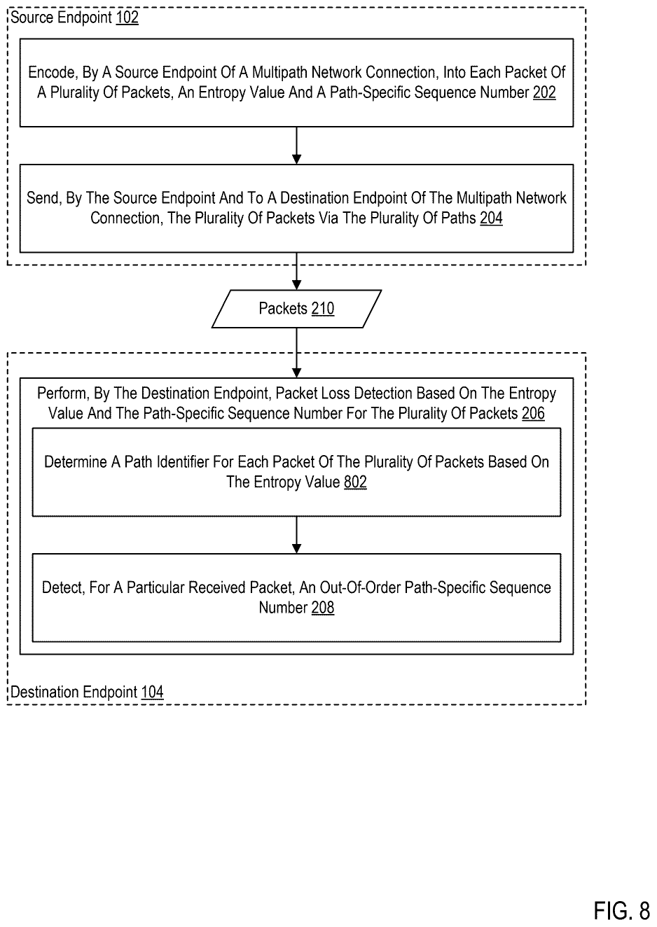

For further explanation, FIG. 8 sets forth a flowchart of another example method of packet loss detection in multipath networks in accordance with some embodiments of the present disclosure. The method of FIG. 8 differs from previous figures in that performing 206, by the destination endpoint 104, packet loss detection based on the entropy value 108 and path-specific sequence number 114 for the plurality of packets 210 also includes determining 802 a path identifier for each packet 210 of the plurality of packets 210 based on the entropy value 108. In some embodiments, in order for the destination endpoint 104 to determine whether the path-specific sequence number 114 of a given packet 210 is in-order or out-of-order, the destination endpoint 104 must determine the path identifier (e.g., PATH_ID or path index) for that packet 210. This may be useful, for example, where entropy values 108 may change over time, causing the particular network path to be used for a particular PATH_ID to change.

In some embodiments, as is set forth above, the entropy value 108 of a packet 210 may include a subset of bits, such as a subset of lowest-order bits, that include the PATH_ID. Accordingly, in some embodiments, the destination endpoint 104 may determine 802 the path identifier for each packet 210 by extracting these lowest-order bits from the entropy value 108 of each packet 210. Readers will appreciate that this approach for determining 802 the path identifier of a packet 210 is merely exemplary and that other approaches may also be used. For example, where the entropy value 108 is calculated from the PATH_ID using some mathematical function, the PATH_ID may be determined by applying an inverse of that function to the entropy value 108.

Consider an example where the destination endpoint 104 receives a first packet 210 having a path-specific sequence number 114 of EV_PSN+3 and an entropy value 108 of X. Assume that the destination endpoint 104 then receives a second packet 210 having a path-specific sequence number 114 of EV_PSN+4 and an entropy value 108 of Y. Further assume that both X and Y encode the same PATH_ID. In some embodiments, without determining the PATH_ID from the included entropy values 108, the destination endpoint 104 may determine that the second packet 210 includes an out-of-order path-specific sequence number 114 as it includes a different entropy value 108 than the first packet 210.

Instead, the destination endpoint 104 may identify the PATH_IDs from the entropy values 108 of the first and second packets 210 and determine that they share the same PATH_ID. Accordingly, the destination endpoint 104 may then determine that the path-specific sequence number 114 for the second packet is in-order relative to the first packet as they share the same PATH_ID despite having different entropy values 108. This prevents false detection of missing packets 210 should the entropy value 108 for a particular PATH_ID change over time, improving overall system performance and utility.

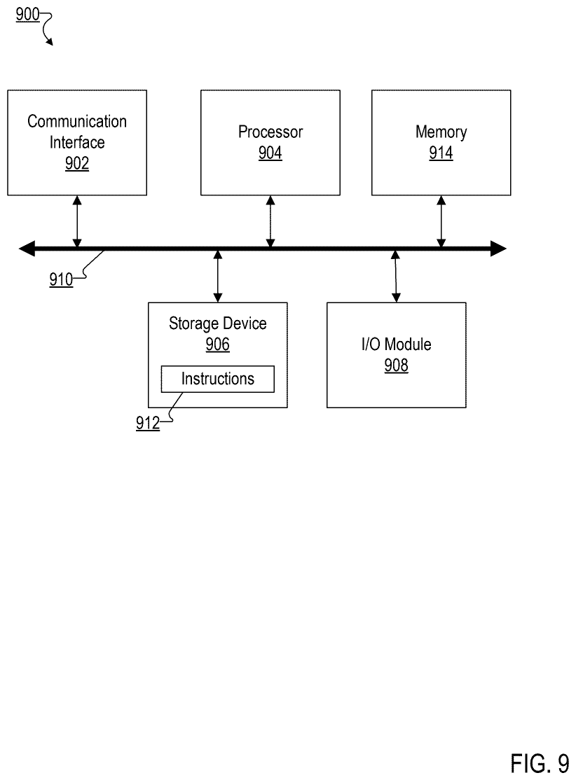

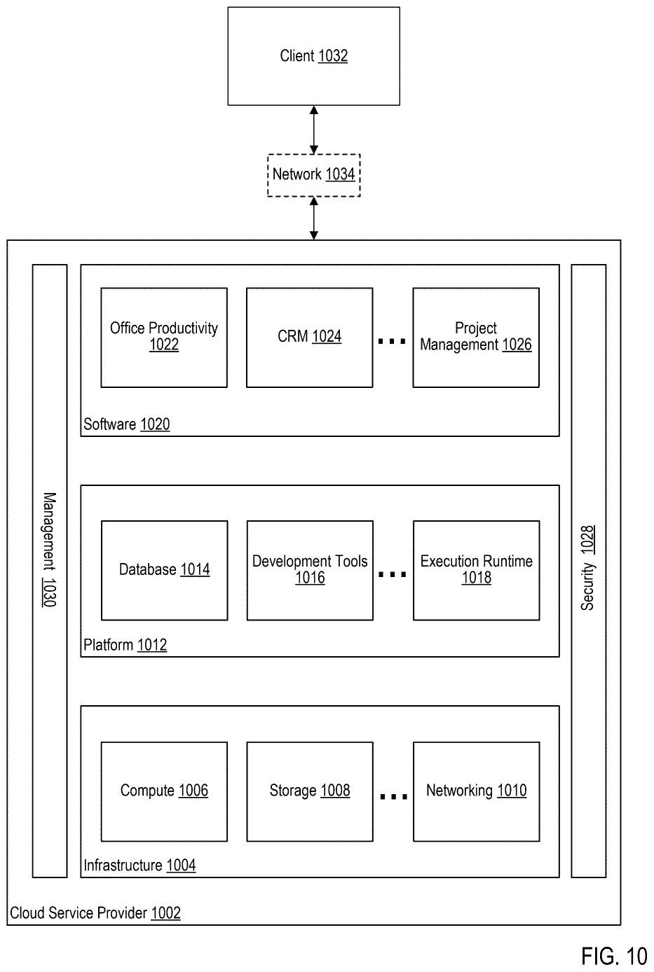

For further explanation, the sections included below provide some details regarding technologies that may be used to support packet loss detection in multipath networks in accordance with some embodiments. For example, FIG. 9 sets forth an example of a computing device that may be used for some portion of packet loss detection in multipath networks in accordance with some embodiments. As an additional example of technologies that may be used to support packet loss detection in multipath networks, FIG. 10 sets forth a block diagram of a cloud service provider 1002 service architecture in accordance with some embodiments of the present disclosure.

For further explanation, FIG. 9 illustrates an exemplary computing device 900 that may be specifically configured to perform one or more of the processes described herein. As shown in FIG. 9, computing device 900 may include a communication interface 902, a processor 904, a storage device 906, an input/output (I/O) module 908, and computer memory 914 communicatively connected one to another via a communication infrastructure 910. While an exemplary computing device 900 is shown in FIG. 9, the components illustrated in FIG. 9 are not intended to be limiting. Additional or alternative components may be used in other embodiments. Components of computing device 900 shown in FIG. 9 will now be described in additional detail.

Communication interface 902 may be configured to communicate with one or more computing devices. Examples of communication interface 902 include, without limitation, a wired network interface (such as a network interface card), a wireless network interface (such as a wireless network interface card), a modem, an audio/video connection, and any other suitable interface.

Processor 904 generally represents any type or form of processing unit capable of processing data and/or interpreting, executing, and/or directing execution of one or more of the instructions, processes, and/or operations described herein. Processor 904 may perform operations by executing computer-executable instructions 912 (e.g., an application, software, code, and/or other executable data instance) stored in storage device 906.

Storage device 906 may include one or more data storage media, devices, or configurations and may employ any type, form, and combination of data storage media and/or device. For example, storage device 906 may include, but is not limited to, any combination of non-volatile media and/or volatile media. Electronic data, including data described herein, may be temporarily and/or permanently stored in storage device 906. For example, data representative of computer-executable instructions 912 configured to direct processor 904 to perform any of the operations described herein may be stored within storage device 906. In some examples, data may be arranged in one or more databases residing within storage device 906.

I/O module 908 may include one or more I/O modules configured to receive user input and provide user output. I/O module 908 may include any hardware, firmware, software, or combination thereof supportive of input and output capabilities. For example, I/O module 908 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 908 is configured to provide graphical data to a display for presentation to a user. The graphical data may be representative of one or more graphical user interfaces and/or any other graphical content as may serve a particular implementation. In some examples, any of the systems, computing devices, and/or other components described herein may be implemented by computing device 900.

For further explanation and as an additional example of a supporting technology for packet loss detection in multipath networks, FIG. 10 sets forth a block diagram of a cloud service provider service architecture in accordance with some embodiments. The cloud service provider 1002 can deliver a variety of resources through a services-based consumption model where resources are consumed on-demand and as-a-service. Cloud service providers can provide services via cloud platforms such as, for example, Microsoft Azure™, Amazon Web Services (‘AWS’)™, Google Cloud Platform (‘GCP’)™, and others. In FIG. 10, the cloud service provider 1002 is accessed from a client device 1034 via a network 1032.

FIG. 10 depicts an embodiment where software 1020 is delivered as a service. Software-as-a-service (‘SaaS’) is a model where software applications are delivered over the internet as-a-service. Rather than installing and maintaining software locally, users can access software via a web browser or other network connected interface, eliminating the need for complex software and hardware management on the client-side. In FIG. 10, as examples of software 1020 that can be delivered as-a-service, the illustrated embodiment includes office productivity 1022 software, customer relationship management (‘CRM’) 1024 software, and project management 1026 software. The office productivity 1022 software can include applications designed to facilitate common business and personal tasks, including word processing applications, applications for spreadsheet creation, presentation design applications, and many others. The CRM 1024 software can include applications for managing a business organization's relationships and interactions with customers and potential customers. The project management 1026 software can include applications designed to help teams plan, organize, and manage projects efficiently by facilitating collaboration and tracking the progress of projects. Readers will appreciate that in other embodiments, other types of software may be delivered using a SaaS model.

FIG. 10 depicts an embodiment where platforms 1012 can be delivered as a service. Platform-as-a-service (‘PaaS’) is a model that provides cloud customers with platform resources that they can use to develop, run, and manage applications without the complexity of such deploying and managing such infrastructure on their own. In FIG. 10, as examples of platform 1012 resources that can be delivered as-a-service, the illustrated embodiment includes database 1014 services, development tools 1016 services, and execution runtime 1018 services. The database 1014 services can be used to provide access to databases without management overhead for the user as the cloud service provider manages the provisioning, scaling, and maintenance of the databases. The development tools 1016 services can provide developers with tools to design, develop, test, and deploy applications without needing to manage the underlying infrastructure. The execution runtime 1018 services can provide environments where applications or other forms of computer program code can be executed, including services to scale the execution environment. Readers will appreciate that in other embodiments, other platform resources may be delivered using a PaaS model.

FIG. 10 depicts an embodiment where infrastructure 1004 can be delivered as a service. Infrastructure-as-a-Service (‘IaaS’) is a model that provides virtualized computing resources over the internet, such that infrastructure such as servers, storage, networks, and others may be leased on demand rather than purchasing and maintaining physical hardware. In FIG. 10, as examples of infrastructure 1004 resources that can be delivered as-a-service, the illustrated embodiment includes compute 1006 services, storage 1008 services, and networking 1010 services. The compute 1006 services can be used to provide on-demand access to computational resources such as VMs, containers, and serverless functions, where the cloud service provider manages the provisioning, scaling, and maintenance of such resources. The storage 1008 services can provide storage resources that can be used to store and access data, without the need for customers to purchase and manage on-premises physical storage resources. The networking 1010 services can provide the ability to create and manage virtualized networking resources such as, for example, virtual private networks (‘VPNs’), firewalls, load balancers, and more. Readers will appreciate that in other embodiments, other infrastructure resources may be delivered using a PaaS model.

The cloud service provider of FIG. 10 also provides management 1030 resources. The management 1030 resources can include, for example, tools and interfaces that enable customers to efficiently deploy, monitor, and manage, their cloud services. Such tools can include web-based management consoles, command-line interfaces (‘CLIs’), APIs, automation tools, and other tools.

The cloud service provider of FIG. 10 also provides security 1028 resources. The security 1028 resources can include, for example, tools and services to help customers protect their cloud environments and ensure compliance with security standards. These tools and services may provide specific aspects of security, including identity and access management, network security, threat detection, compliance management, and others.

Readers will appreciate that many of the components described above may be delivered as services from a cloud service provider. For example, the virtual machines, containers, and pods described above may all be delivered via a cloud service provider. In other embodiments, other forms of compute resources may be used in place of the virtual machines or other compute resource. For example, AWS EC2 instances or other form of cloud compute instances may be utilized in place of the virtual machines.

Advantages and Features of the Present Disclosure Can Be Further Described by the following statements

1. A method of packet loss detection in multipath networks, comprising: encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path; sending, by the source endpoint and to a destination endpoint of the multipath network connection, the plurality of packets via the plurality of paths; and performing, by the destination endpoint, packet loss detection based on the entropy value and the path-specific sequence number for the plurality of packets.

2. The method of statement 1, wherein performing packet loss detection comprises detecting, for a particular received packet, an out-of-order path-specific sequence number.

3. The method of any combination of one or more of statements 1 or 2, further comprising requesting, by the destination endpoint and from the source endpoint, in response to detecting one or more missing packets, the one or more missing packets.

4. The method of any combination of one or more of statements 1-3, wherein sending the plurality of packets via the plurality of paths comprises sending each packet of the plurality of packets along a next path of a rotating sequence of the plurality of paths.

5. The method of any combination of one or more of statements 1-4, wherein sending the plurality of packets via the plurality of paths comprises updating, by the source endpoint, a particular entropy value corresponding to a particular path in response to receiving a congestion control signal for the particular path.

6. The method of any combination of one or more of statements 1-5, wherein the particular entropy value comprises a constant component and a dynamically incremented component and wherein updating the particular entropy value comprises incrementing the dynamically incremented component of the particular entropy value.

7. The method of any combination of one or more of statements 1-6, wherein the entropy value comprises a User Datagram Protocol (UDP) source port.

8. A method of packet loss detection in multipath networks, comprising: encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path; and sending, by the source endpoint and to a destination endpoint of the multipath network connection, the plurality of packets via the plurality of paths; wherein the destination endpoint is configured to perform packet loss detection based on the entropy value and the path-specific sequence number for the plurality of packets.

9. The method of statement 8, wherein the destination endpoint is configured to perform packet loss detection by detecting, for a particular received packet, an out-of-order path-specific sequence number.

10. The method of any combination of one or more of statements 8 or 9, further comprising sending, by the source endpoint and to the destination endpoint, in response to a request for one or more missing packets from the destination endpoint, the one or more missing packets.

11. The method of any combination of one or more of statements 8-10, wherein sending the plurality of packets via the plurality of paths comprises sending each packet of the plurality of packets along a next path of a rotating sequence of the plurality of paths.

12. The method of any combination of one or more of statements 8-11, wherein sending the plurality of packets via the plurality of paths comprises updating, by the source endpoint, a particular entropy value corresponding to a particular path in response to receiving a congestion control signal for the particular path.

13. The method of any combination of one or more of statements 8-12, wherein the particular entropy value comprises a constant component and a dynamically incremented component and wherein updating the particular entropy value comprises incrementing the dynamically incremented component of the particular entropy value.

14. The method of any combination of one or more of statements 8-13, wherein the entropy value comprises a User Datagram Protocol (UDP) source port.

15. A method of packet loss detection in multipath networks, comprising: receiving, by a destination endpoint of a multipath network connection and from a source endpoint, a plurality of packets, wherein each packet of the plurality of packets comprises an entropy value and a path-specific sequence number, wherein the entropy value is included in a plurality of entropy values each corresponding to a different path of a plurality of paths of the multipath network connection, and wherein the path-specific sequence number comprises a value in a sequence of values for each subset of the plurality of packets sharing a same network path; and performing, by the destination endpoint, packet loss detection based on the entropy value and the path-specific sequence number for the plurality of packets.

16. The method of statement 15, wherein performing packet loss detection comprises detecting, for a particular received packet, an out-of-order path-specific sequence number.

17. The method of any combination of one or more of statements 15-16, wherein performing packet loss detection comprises determining, by the destination endpoint, a path identifier for each packet of the plurality of packets based on the entropy value.

18. The method of any combination of one or more of statements 15-17, wherein a subset of bits encoding the entropy value comprises the path identifier.

19. The method of any combination of one or more of statements 15-18, further comprising requesting, by the destination endpoint and from the source endpoint, in response to detecting one or more missing packets, the one or more missing packets.

20. The method of any combination of one or more of statements 15-19, wherein the entropy value comprises a User Datagram Protocol (UDP) source port.

Although some embodiments are described largely in the context of a system, method, or in some other way, readers will recognize that embodiments of the present disclosure may also take the form of a computer program product disposed upon computer readable storage media for use with any suitable processing system. Such computer readable storage media may be any storage medium for machine-readable information, including magnetic media, optical media, solid-state media, or other suitable media. Examples of such media include magnetic disks in hard drives or diskettes, compact disks for optical drives, magnetic tape, and others as will occur to those of skill in the art. Persons skilled in the art will immediately recognize that any computer system having suitable programming means will be capable of executing the steps described herein as embodied in a computer program product. Persons skilled in the art will recognize also that, although some of the embodiments described in this specification are oriented to software installed and executing on computer hardware, nevertheless, alternative embodiments implemented as firmware or as hardware are well within the scope of the present disclosure.

Readers will appreciate that some embodiments are described in which computer program instructions are executed on computer hardware such as, for example, one or more computer processors. Readers will appreciate that in other embodiments, computer program instructions may be executed on virtualized computer hardware (e.g., one or more virtual machines), in one or more containers, in one or more cloud computing instances (e.g., one or more AWS EC2 instances), in one or more serverless compute instances offered such as those offered by a cloud services provider, in one or more event-driven compute services such as those offered by a cloud services provider, or in some other execution environment.

In some examples, a non-transitory computer-readable medium storing computer-readable instructions may be provided in accordance with the principles described herein. The instructions, when executed by a processor of a computing device, may direct the processor and/or computing device to perform one or more operations, including one or more of the operations described herein. Such instructions may be stored and/or transmitted using any of a variety of known computer-readable media.

A non-transitory computer-readable medium as referred to herein may include any non-transitory storage medium that participates in providing data (e.g., instructions) that may be read and/or executed by a computing device (e.g., by a processor of a computing device). For example, a non-transitory computer-readable medium may include, but is not limited to, any combination of non-volatile storage media and/or volatile storage media. Exemplary non-volatile storage media include, but are not limited to, read-only memory, flash memory, a solid-state drive, a magnetic storage device (e.g., a hard disk, a floppy disk, magnetic tape, etc.), ferroelectric random-access memory (“RAM”), and an optical disc (e.g., a compact disc, a digital video disc, a Blu-ray disc, etc.). Exemplary volatile storage media include, but are not limited to, RAM (e.g., dynamic RAM).

One or more embodiments may be described herein with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

While particular combinations of various functions and features of the one or more embodiments are expressly described herein, other combinations of these features and functions are likewise possible. The present disclosure is not limited by the particular examples disclosed herein and expressly incorporates these other combinations.

What is claimed is:

1. A method of packet loss detection in multipath networks, comprising:
encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path;
sending, by the source endpoint and to a destination endpoint of the multipath network connection, the plurality of packets via the plurality of paths; and
performing, by the destination endpoint, packet loss detection based on the entropy value and the path-specific sequence number for the plurality of packets.

2. The method of claim 1, wherein performing packet loss detection comprises detecting, for a particular received packet, an out-of-order path-specific sequence number.

3. The method of claim 1, further comprising requesting, by the destination endpoint and from the source endpoint, in response to detecting one or more missing packets, the one or more missing packets.

4. The method of claim 1, wherein sending the plurality of packets via the plurality of paths comprises sending each packet of the plurality of packets along a next path of a rotating sequence of the plurality of paths.

5. The method of claim 1, wherein sending the plurality of packets via the plurality of paths comprises updating, by the source endpoint, a particular entropy value corresponding to a particular path in response to receiving a congestion control signal for the particular path.

6. The method of claim 5, wherein the particular entropy value comprises a constant component and a dynamically incremented component and wherein updating the particular entropy value comprises incrementing the dynamically incremented component of the particular entropy value.

7. The method of claim 1, wherein the entropy value comprises a User Datagram Protocol (UDP) source port.

8. A method of packet loss detection in multipath networks, comprising:
encoding, by a source endpoint of a multipath network connection, into each packet of a plurality of packets, an entropy value and a path-specific sequence number, wherein the entropy value is included in a plurality of entropy values each corresponding to a different path of a plurality of paths of the multipath network connection, and wherein the path-specific sequence number comprises a next value in a sequence of values for each subset of the plurality of packets sharing a same network path; and
sending, by the source endpoint and to a destination endpoint of the multipath network connection, the plurality of packets via the plurality of paths;
wherein the destination endpoint is configured to perform packet loss detection based on the entropy value and the path-specific sequence number for the plurality of packets.

9. The method of claim 8, wherein the destination endpoint is configured to perform packet loss detection by detecting, for a particular received packet, an out-of-order path-specific sequence number.

10. The method of claim 8, further comprising sending, by the source endpoint and to the destination endpoint, in response to a request for one or more missing packets from the destination endpoint, the one or more missing packets.

11. The method of claim 8, wherein sending the plurality of packets via the plurality of paths comprises sending each packet of the plurality of packets along a next path of a rotating sequence of the plurality of paths.

12. The method of claim 8, wherein sending the plurality of packets via the plurality of paths comprises updating, by the source endpoint, a particular entropy value corresponding to a particular path in response to receiving a congestion control signal for the particular path.

13. The method of claim 12, wherein the particular entropy value comprises a constant component and a dynamically incremented component and wherein updating the particular entropy value comprises incrementing the dynamically incremented component of the particular entropy value.

14. The method of claim 8, wherein the entropy value comprises a User Datagram Protocol (UDP) source port.

15. A method of packet loss detection in multipath networks, comprising:
receiving, by a destination endpoint of a multipath network connection and from a source endpoint, a plurality of packets, wherein each packet of the plurality of packets comprises an entropy value and a path-specific sequence number, wherein the entropy value is included in a plurality of entropy values each corresponding to a different path of a plurality of paths of the multipath network connection, and wherein the path-specific sequence number comprises a value in a sequence of values for each subset of the plurality of packets sharing a same network path; and
performing, by the destination endpoint, packet loss detection based on the entropy value and the path-specific sequence number for the plurality of packets.

16. The method of claim 15, wherein performing packet loss detection comprises detecting, for a particular received packet, an out-of-order path-specific sequence number.

17. The method of claim 15, wherein performing packet loss detection comprises determining, by the destination endpoint, a path identifier for each packet of the plurality of packets based on the entropy value.

18. The method of claim 17, wherein a subset of bits encoding the entropy value comprises the path identifier.

19. The method of claim 15, further comprising requesting, by the destination endpoint and from the source endpoint, in response to detecting one or more missing packets, the one or more missing packets.

20. The method of claim 15, wherein the entropy value comprises a User Datagram Protocol (UDP) source port.
